(19) United States
(12) Patent Application Publication
(10) Pub. No.: US 2026/0238694 A1
(43) Pub. Date: Aug. 13, 2026

(54) SYSTEMS AND METHODS FOR ORGANIZATION BASED MAPPING OF NETWORK DRIVES

(71) Applicant: SAUDI ARABIAN OIL COMPANY, Dhahran (SA)

(72) Inventors: Taher A. ALWUSAIBIE, Dhahran (SA); Anthony G. MURDOCH, Dhahran (SA); Khalid H. ALQAHTANI, Dhahran (SA); Osamah A. ALBUGEAEY, Dhahran (SA); Mohammed S. ALLOGMANI, Dhahran (SA); Saad F. ANAZI, Dhahran (SA)

(73) Assignee: SAUDI ARABIAN OIL COMPANY, Dhahran (SA)

(21) Appl. No.: 19/051,934

(22) Filed: Feb. 12, 2025

(51) Int. Cl. H04L 67/1097; G06F 9/451

(52) U.S. Cl. CPC H04L 67/1097; G06F 9/451

(57) ABSTRACT

Systems and methods described herein may include a drive mapping service implemented on a first unit and configured to communicate over a data network with one or more remote computing devices, the first unit having a memory and one or more processors coupled to the memory, a dynamic mapping toolkit implemented on the drive mapping service, the dynamic mapping toolkit configured to cause the one or more processors to obtain a set of user information, in response to the user information, construct one or more network drive mappings, and output the one or more network drive mappings to the one or more remote computing devices, the one or more network drive mappings configured to generate one or more corresponding network drive mappings at the one or more remote computing devices.

### BACKGROUND

Conventional methods of performing network drive mappings allow organizations to establish connections between client devices and network storage resources, facilitating file sharing, data access, and collaboration within a networked environment. These methods are typically straightforward to implement and can be managed using built-in operating system tools, making them accessible for IT administrators. Despite the utility of conventional network drive mappings, several challenges persist that can impact their efficiency and reliability. One challenge is the manual configuration required, which can be time-consuming and prone to human error. Additionally, maintaining consistent drive mappings across multiple devices and users can be complex, especially in large organizations with diverse IT environments. Another issue is the limited scalability of traditional mapping methods, which may not adequately support dynamic or cloud-based infrastructures. Furthermore, security concerns arise from the potential for unauthorized access to network drives, necessitating robust access control and monitoring mechanisms.

Although conventional techniques for network drive mappings have been developed and refined over many years, they may still be inadequate to achieve optimal results. Accordingly, there is an impetus to improve network drive mapping techniques to overcome current technological challenges by implementing improvements including, for example: enhancing the reliability of network drive mappings, increasing the accuracy of network drive mappings, reducing inefficiencies associated with network drive mappings, increasing the scalability of network drive mappings, reducing errors associated with network drive mappings, decreasing the cost of network drive mappings, and the like.

Consequently, there exists a need for further improvements to network drive mapping technology to overcome the aforementioned technical challenges and other challenges not mentioned.

### SUMMARY

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a system described herein may include a drive mapping service implemented on a first unit and configured to communicate over a data network with one or more remote computing devices, the first unit having a memory and one or more processors coupled to the memory. The system may further include a dynamic mapping toolkit implemented on the drive mapping service, the dynamic mapping toolkit configured to cause the one or more processors to perform one of more steps. The one or more steps may include obtaining a set of user information. The one or more steps may include, in response to the user information, constructing one or more network drive mappings, The one or more steps may include outputting the one or more network drive mappings to the one or more remote computing devices, the one or more network drive mappings configured to generate one or more corresponding network drive mappings at the one or more remote computing devices.

In another embodiment consistent with the present disclosure, a device described herein may include a drive mapping client implemented on the device and configured to communicate over a data network with a first unit. The device may further include a dynamic mapping tool implemented on the drive mapping client, the dynamic mapping tool configured to cause the one or more processors to perform one or more steps. The one or more steps may include outputting a set of user information. The one or more steps may include obtaining, from the first unit, one or more network drive mappings based on the set of user information. The one or more steps may include generating one or more corresponding network drive mappings. The one or more steps may include storing the one or more corresponding network drive mappings via one or more registration keys at the device.

Other aspects of the present disclosure provide: one or more devices (e.g., apparatuses) operable, configured, or otherwise adapted to perform the aforementioned methods as well as those described elsewhere herein; a non-transitory, computer-readable media including computer-executable instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus including means for performing the aforementioned methods as well as those described elsewhere herein. By way of example, an apparatus may include a processing system, or processing systems cooperating over one or more message passing interfaces.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

To easily identify the discussion of any particular element or act, the most significant digit or digits in a reference number refer to the figure number in which that element is first introduced.

FIG. 1 is a flow diagram illustrating an example of an enhanced procedure for defining categories of network drive mappings, according to one or more embodiments of the present disclosure.

FIG. 2 is a flow diagram illustrating an example of an enhanced procedure for mapping user network drives, according to one or more embodiments of the present disclosure.

FIG. 3 is a flow diagram illustrating an example of an enhanced procedure for mapping network using drives using registry key storage, according to one or more embodiments of the present disclosure.

FIG. 4 is an architecture diagram illustrating an example of an enhanced mapping architecture for mapping network using drives, according to one or more embodiments of the present disclosure.

FIG. 5 is a flow diagram illustrating an example method for mapping network using drives by a system, according to one or more embodiments of the present disclosure.

FIG. 6 is a flow diagram illustrating an example method for mapping network using drives by a device, according to one or more embodiments of the present disclosure.

FIG. 7 is a diagram of a system having a device for network drive mapping, implemented according to at least one aspect of the present disclosure.

FIG. 8 is a diagram of a system having a device for network drive mapping, implemented according to at least one aspect of the present disclosure.

FIG. 9 is a block diagram of a computer system that may be used to implement one or more of the systems or methods described herein in accordance with certain embodiments.

FIG. 10 depicts a cloud computing environment that can be used to perform one or more actions according to an aspect of the present disclosure.

FIG. 11 is a block diagram of a computer system that may be used to implement one or more of the systems or methods described herein in accordance with certain embodiments.

### DETAILED DESCRIPTION

Aspects of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter. However, it will be apparent to one of ordinary skill in the art that the aspects disclosed herein may be practiced without these specific details, or with details that are not described herein in the interest of clarity. Thus in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

Aspects in accordance with the present disclosure generally relate to performing network drive mappings by an enhanced mapping architecture, and more particularly to methods and processes for automating the organization-based mapping of network drives as implemented on an enhanced mapping architecture. This includes establishing drive configurations that are constructed and evaluated to map network drives to appropriate assigned to users when users login via one or more user devices (e.g., computers, consoles, laptops, tablets, mobile phones, and the like). “Appropriate” may refer to the suitability and correctness of network drive mappings based on the specific needs and roles of users within an organization to ensure that users have access to the necessary resources to perform their tasks efficiently and securely. The process is adaptive and can be extended to enable mapping based on group memberships, such as those defined in the “active directory,” which is further described below. The enhanced mapping architecture stores these configurations to be used by an end-user automated engine that launches when users access their computers, examining the user and making a call to the backend system to retrieve the required network mappings. The end-user automated engine at the enhanced mapping architecture utilizes this input to create the proper network drives for the user, granting seamless access to organizational-based network drives. This may facilitate efficient network administration and may address challenges associated with conventional ways of performing network drive mappings.

The enhanced mapping architecture may include dynamic procedures for delegation by system administrators to configure one or more mapping rules, providing system administrators with the authority and tools needed to manage network drive mappings effectively. Procedures implemented on the enhanced mapping architecture may support flexible network drive mappings for both personal and organizational drives, ensuring that users have access to the appropriate resources based on their roles and needs. Additionally, the process includes adaptive drive mapping configuration based on group membership of other systems, such as Active Directory, allowing for dynamic and context-sensitive drive mappings. Filtering capabilities are also included to simplify the job of system administrators, making it easier to manage and configure drive mappings. Additionally, the enhanced mapping architecture may be able to test network drives that may be mapped, providing a comprehensive view of network drives for any user and ensuring that mappings are accurate and functional. Furthermore, the enhanced mapping architecture may be able to implement procedures which include an automated mechanism for regularly pushing the end-user automated engine at the enhanced mapping architecture, ensuring that updates and configurations are consistently applied. During this procedure, the end-user automated engine retrieves the mapping seamlessly every time a user accesses any computer, providing a smooth and efficient user experience.

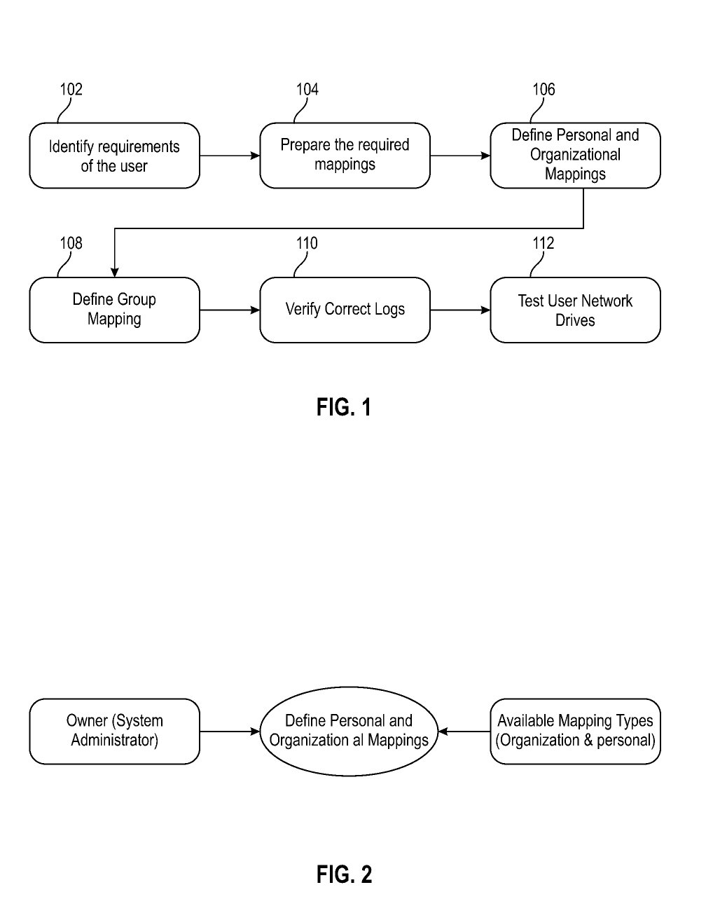

FIG. 1 depicts a flow diagram of an example method 100 implemented by an enhanced mapping architecture. Method 100 may be used to achieve an adaptive organization-based mapping of network drives that may be tailored to specific organization considerations. At operation 102, the enhanced mapping architecture may identify certain user specifications (e.g., requirements, personal or organizations preferences, and the like). At operation 104, the enhanced mapping architecture may proceed to preparing a set of candidate mappings for the user. Candidate mapping may be based on based on a user's organization code or group membership. At operation 106, an interface (e.g., a drive mapping management interface) at the enhanced mapping architecture is utilized to construct (e.g., create) personal and/or organizational mappings for a user (e.g., based on the candidate mappings). At operation 108, the interface at the enhanced mapping architecture is utilized to construct group mappings. In some cases, the group mappings of operation 108 may be complimentary to the personal and/or organizational mappings for a user constructed at operation 106. In some cases, operation 108 may be optional. At operation 110, the enhanced mapping architecture verified that logs for the constructed user mappings are correct. Finally, at operation 112, the enhanced mapping architecture tests user network drives to ensure that the correct mappings are reflected for the user at each user device.

In at least one aspect, the enhanced mapping architecture may support at least three types of drive mappings for a user device. In at least one example, where the enhanced mapping architecture is associated with a file system unit (e.g., a file server, such as a Microsoft network file system), the three drive mappings may be associated with different types of network drives that can be constructed on a user device based on the type of usage required by the organization.

The first type of network drive mapping is based on a personal (P:) drive. The personal drive may be mapped to a user folder in a user's department storage folder. This may allow a user to have full ownership and control over a subset of the files based on the mappings configured. The second type of network drive mapping is based on a group data (O:) drive. The group data drive may be mapped to the department's group data folder, facilitating shared access and collaboration within the department. The third mapping, which can be considered an additional group mapping, may be based on a relationship that links drive letters to group memberships, enabling the organization to adaptively configure the mapping requirements of any business entity that belongs to a group of users, typically based on an active directory. The active directory is a directory service which provides a variety of network services, including authentication, authorization, and directory services. It may allow administrators to manage permissions and access to network resources, ensuring secure and organized management of user data and network infrastructure. System administrators may configure the above mappings based on instant needs to accommodate any requirement for adaptive drive mapping.

In at least one aspect, the enhanced mapping architecture may include a drive mapping management interface. The drive mapping management interface may be a management tool that enables system administrators to configure the network drives described in the previous section. In some cases, the drive mapping management interface may be accessible on a user device that supports a web browser.

As illustrated in the diagram of FIG. 2, the drive mapping management interface may allow system administrators to add and maintain shares that may be mapped (e.g., appropriately mapped) to a personal (P:) drive and/or a Group Data (O:) drive. Multiple operations may be supported to add, update, or delete mappings. Additionally, filter and clear options may be available. These mappings may be utilized by an end-user automated engine to create the actual drive mappings on the computers once users log in. This feature may allows system administrators to add and maintain the shares. I may also allow system administrators to extend the personal and organizational mappings to any type of mappings based on group membership. In at least one example, any drive mapping letter can be utilized via a drive mapping management interface to allow extensible functionality for users. These mappings may be utilized by the end-user automated engine to construct the drive mappings on user devices upon login.

In one aspect, the personal drive may provide full ownership of the data to the individual user, designed to store personal files and documents, ensuring that each user has a dedicated space for their data that is not accessible by others. This drive may be mapped to a specific drive letter, such as P:, and may be used for personal storage needs. The group data drive may be used for sharing information within a department or group, allowing multiple users within the same department to access and collaborate on shared files and documents. The group data drive may be mapped to a common drive letter, such as O:, and is configured to facilitate departmental collaboration and data sharing.

The drive mapping management interface may include a plurality of screens for system administration. In one example, a log screen may allow system administrators to view and audit all actions performed within the system, allowing them to assess any auditing or security requirements. In another example, a user test screen provides a method for system administrators to test and identify what drive mappings may be applied to a given user according to their user account, department, and group membership. The user test screen may also show a comprehensive view of what users will receive from the automated engine once they log in to their computers.

The information, configuration, and logs created by the drive mapping management interface may be maintained in a back-end database. The back-end database may be based, for example, an SQL Server, which may store the data to support procedures implemented at the enhanced mapping architecture. Three database tables may be used at the back-end database: “deptMapping,” which may contain the organization-to-user share as well as organization share mappings; logs, which may include the logs generated by the drive mapping management interface; and “specialMapping,” which includes the group mappings.

In at least one aspect, the enhanced mapping architecture may include a drive mapping web service (DMS). The DMS may be a web service that the end-user automated engine may call when it wants to identify a set of candidate mappings for the logged-in user. In one example, candidate mappings may be identified based on intelligent usage of the user's access token.

The DMS may provides two functions as part of the enhanced mapping architecture: “getDeptShare,” which returns the user and organization shares for the logged-in user based on what is configured by the system administrator, and “getSpecialShare,” which returns the drive letter and the network share path that will be assigned to the logged-in user based on their group membership.

In at least one aspect, the enhanced mapping architecture may include a drive mapping client (DMC). The DMC may be an automated end-user engine that runs on client devices when users access their computers, ensuring successful and adaptive mappings.

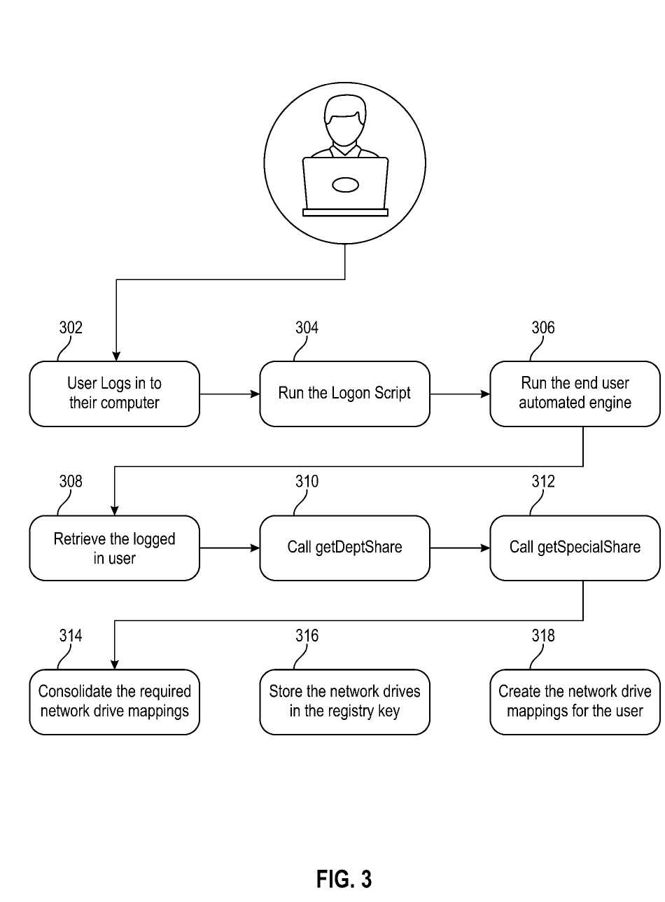

The diagram of FIG. 3 illustrates example method 300 for adaptive mapping at an end-user automated engine, implemented by an enhanced mapping architecture via a DMC. The method 300 begins at operation 302, with a user logging in to one or more devices. At operation 304, the enhanced mapping architecture deploys a logon script in an active directory group policy object (GPO) linked to an organizational unit (OU) that holds end-user accounts. In one example, the enhanced mapping architecture may generate a custom script for the instant user, providing an adaptable set of instructions for onboarding the network mapping onto the user. In one example, may use of the user’s windows logon token to pass to the DMS, which performs the calculations and returns a table back to the DMC to act on. It then can execute the script or (presumably) allow the user to store table for future use. At operation 306, the enhanced mapping architecture activates the DMC at the end-user automated engine. At operation 308, the enhanced mapping architecture retrieves the logged in user information from the local computer. At operation 310, the enhanced mapping architecture calls the DMS via “getDeptShare” to obtain department information for the user. At operation 312, the enhanced mapping architecture calls the DMS via “getSpecialShare” to obtain specialty information for the user. At operation 314, the enhanced mapping architecture consolidates the required network drive mappings. At operation 316, the enhanced mapping architecture stores the network drives locally on the computer in registry keys. At operation 318, the enhanced mapping architecture constructs the network drive mappings for the user. In at least one example, operation 318 is implemented when a client makes a web service call to determine which drives should be mapped.

Method 300 is flexible and can overcome system failures, adaptively recovering to enable users to access their network drives. The configuration of the network mappings may be stored in a registry key on the computer when retrieved, allowing the system to perform the last recorded mappings if the DMS service is not available.

In one non-limiting example, logon scripts and GPOs may be utilized to ensure a robust rollout of the systems and methods provided herein, organizing configurations to ensure consistency and efficiency in the deployment process. Management of group mapping capability through the interface allows business administrators to extend personal and organizational mappings to any type of mappings, providing flexibility and adaptability.

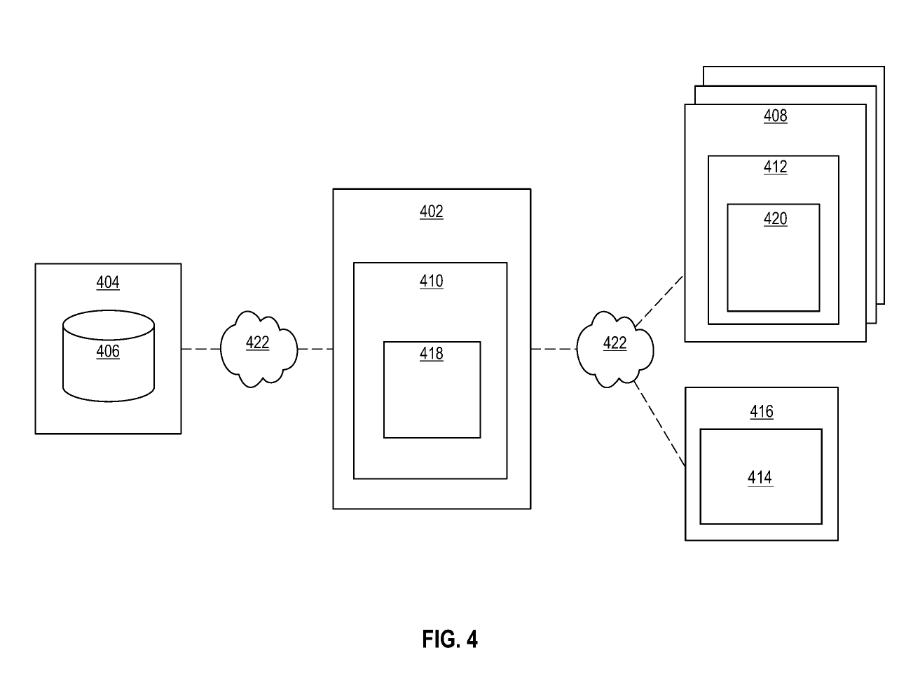

FIG. 4 illustrates an example enhanced mapping architecture 400, which may be understood to be similar to any of the enhanced mapping architecture described herein. The enhanced mapping architecture includes a front-end unit 402, a back-end unit 404, a file system database 406, one or more user devices 408, a DMS 410, a DMC 412, a drive mapping interface 414, a system administrator device 416, a dynamic mapping toolkit 418, a dynamic mapping tool 420, and a network 422. Front-end unit 402 is communicatively coupled to back-end unit 404 via network 422. In one embodiment, back-end unit 404 may include file system database 406. In another embodiment, the back-end unit 404 may be communicatively coupled to the file system database 406 via network 422. The front-end unit 402 may include a DMS 410. DMS 410 may include a dynamic mapping toolkit 418. Front-end unit 402 may be communicatively coupled to one or more user devices 408 via network 422. One or more user devices 408 may include DMC 412. DMC 412 may include dynamic mapping tool 420. The front-end unit 402 may be communicatively coupled to the system administrator device 416 via network 422. The system administrator device 416 may include drive mapping interface 414.

In at least one aspect, each of front-end unit 402 and back-end unit 404 may have at least one memory and one or more processors having computer readable instructions stored thereon, which are capable of implementing mapping schemes as part of the enhanced mapping architecture. In at least one aspect, front-end unit 402 and/or back-end unit 404 may have at least one memory and one or more processors having computer readable instructions stored thereon, which are capable of implementing enhanced mapping architecture schemes as part of the function of the enhanced mapping architecture. The one or more processor(s) of front-end unit 402 and/or back-end unit 404 may be central processing units (CPUs). The one or more processor(s) of front-end unit 402 and/or back-end unit 404 may be graphics processing units (GPUs). Where there is more than one processor, each processor may operate independent from one another or as part of the same network of controllers and/or systems. Where multiple processors are part of the same network of controllers and/or systems, they may operate in sequence with one another, in parallel with one another, as physical components of a shared virtual machine, or as components of server-less network capable of processing decomposed flow data.

In at least one aspect, network 422 may be practically implemented as one or more networks. Network 422 may be a wired network, a wireless network, or a combination of both. In at least one aspect, a wireless network may include a wireless local area network (WLANs) (e.g., a wireless fidelity (Wi-Fi) network), a wireless personal area networks (WPANs) (e.g., a Bluetooth network, a Zigbee network), a wireless metropolitan area network (WMANs) (e.g., a worldwide interoperability for microwave access (WiMAX) network), a wireless wide area network (WWANs) (e.g., a fourth generation long-term evolution (4G LTE) network, a fifth generation new radio (5G NR) network, satellite networks, mesh networks, ad hoc networks, near field communication (NFC) networks, infrared (IR) communication networks, ultra-wideband (UWB) networks, long range wide area networks (LoRaWAN) (e.g., a network optimized for Internet-of-Things (IoT) applicability), and the like.

In at least one aspect, the file system database 406 may include one or more of relational databases (RDBMS) which use structured query language (SQL) for data management, NoSQL databases (e.g., document stores, key-value stores, column-family stores, graph databases), in-memory databases, NewSQL databases, time-series databases, object-oriented databases, hierarchical databases, network databases, distributed databases, cloud databases, multimodel databases, embedded databases, and the like. File system database 406 may be treated as a data warehouse, data lake, data well, or another storage system. File system database 406 may be optimized for querying and analysis, allowing the enhanced data processing architecture methods described herein (e.g., method 300, method 500).

In at least one aspect, dynamic mapping toolkit 418 may be an application, such as, an application running under control of an operating system on front-end unit 402 or a web application operating which may be accessed via network 422 and via a browser at one or more user devices 408. Front-end unit 402 may also include or be coupled to a web server (not shown). Dynamic mapping toolkit 418 may be implemented in software, firmware, hardware or any combination thereof.

In at least one aspect, one or more user devices 408 of enhanced mapping architecture 400 of FIG. 4 includes DMC 412, which may utilize a dynamic mapping tool 420. In at least one aspect, dynamic mapping toolkit 418 may be accessed by one or more user devices 408 via network 422. In at least one aspect, one or more user devices 408 can be any electronic computing device by a user. One or more user devices 408 may be a computing device that has a display. A user can enter control inputs through a user interface (such as a keyboard, microphone, or touchscreen). For example, one or more user devices 408 can include, but is not limited to, a mobile computing device (such as a smartphone or tablet computer), wearable computing device (such as a smart watch or headset), a desktop computer, laptop computer, set-top box, smart television, smart display screen, kiosk, or other type of computing device having at least one processor and computer-readable memory. In addition to at least one processor and memory, such a computing device may include software, firmware, hardware, or a combination thereof. Software may include one or more applications, a browser, and an operating system. Hardware can include, but is not limited to, a processor, memory, display or other input/output device. A communication interface and transceiver can be included to perform data communication (wired or wireless) over network 422. In at least one aspect, one or more user devices 408 may be a remote computing device that includes a network drive mapping tool (e.g., dynamic mapping tool 420) having a user-interface configured to allow a user to dynamically connect to a network of drives via dynamic mapping.

One or more user devices 408 may also include a browser (not shown), which may include dynamic mapping tool 420. Dynamic mapping tool 420 may be an application, such as, an application running under control of an operating system on one or more user devices 408 or a web application operating which may be accessed via network 422 and via the browser. Dynamic mapping tool 420s may be configured or otherwise arranged to access data from dynamic mapping toolkit 418 to, for example, have constructing mappings applied to the one or more user devices 408.

In at least one additional aspect, the enhanced data processing architecture of FIG. 4 may utilize serverless computing, allowing the architecture to implement custom features (e.g., custom code) in response to specific events, such as data updates or user actions.

Implementation of methods and systems provided herein may allow for the delegation of system administrators to configure the mapping rules, providing flexibility in network drive mappings for both personal and organizational-based drives. Filtering capabilities may be included to simplify the job of system administrators. Additionally, methods and system provided herein has the capability to test the network drives that may be mapped, providing a comprehensive view of network drives for any user. The process includes an automated mechanism for regularly pushing the end-user engine, ensuring that updates and configurations are consistently applied. The end-user automated process retrieves the mapping seamlessly every time a user accesses any computer, ensuring a smooth and efficient user experience.

In one non-limiting example, a large enterprise that faces issues managing network drive mappings for their organization may implement systems and methods provided herein to provide flexibility for such organizations.

In one non-limiting example, the systems and methods provided herein include a fault tolerance mechanism that utilizes registry keys to overcome connectivity failures, ensuring that the correct network drive mappings are delivered to users when they log in to their computers. This provides a reliable way to maintain drive mappings even in the event of network issues. The data model and attributes for each table in the database may be configured or otherwise arranged to host and store the data for each interface in the web application. A drive mapping management interface enables business administrators to configure network drives according to the available types, including a department mapping capability that allows administrators to add and maintain shares for both personal and group data drives.

### Example Method

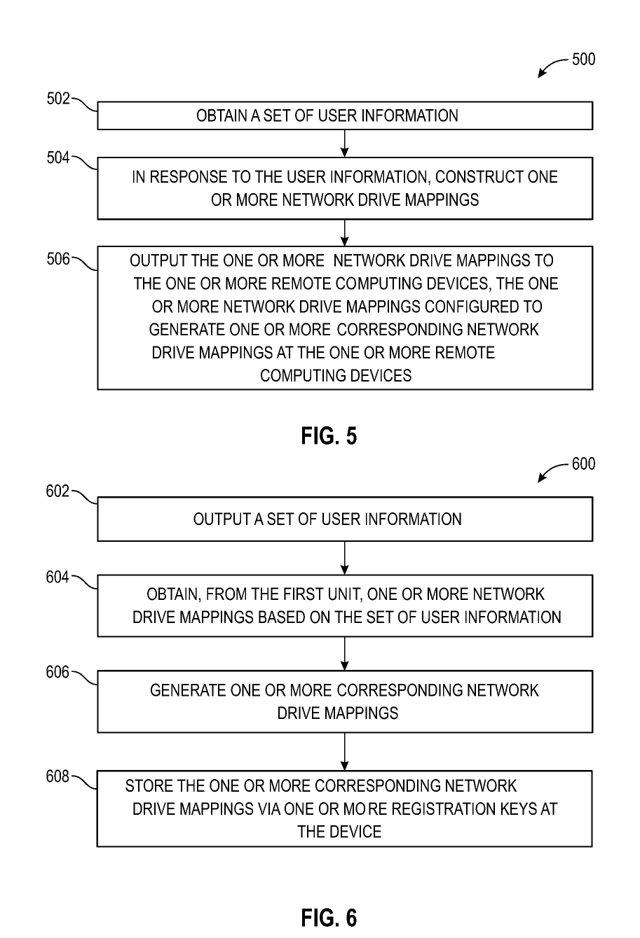

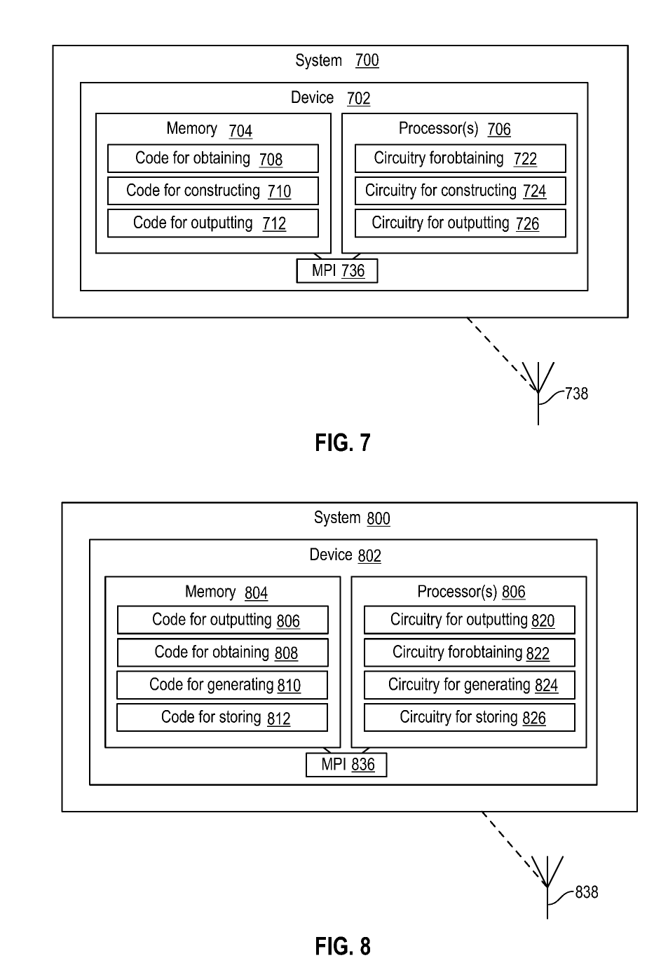

FIG. 5 is a schematic flowchart of an example method 500 for network drive mapping by one or more processors, such as processors of enhanced mapping architecture 400 of FIG. 4 and/or the processors of the system 700 of FIG. 7.

Method 500 begins at operation 502 one or more processors obtaining a set of user information. In one example, the user information is generated based on at least one login event from one or more users at the one or more computing devices.

Method 500 continues to operation 504 with one or more processors, in response to the user information, constructing one or more network drive mappings. In one example, the one or more network drive mappings include at least one of personal drive mappings and business mappings. In one example, the one or more network drive mappings include group mappings.

Method 500 continues to operation 506 with one or more processors outputting the one or more network drive mappings to the one or more remote computing devices, the one or more network drive mappings configured to generate one or more corresponding network drive mappings at the one or more remote computing devices.

In at least one aspect, method 500 may include an operation by one or more processors, after outputting the one or more drive mappings, to detect receipt of the one or more network drive mappings at the one or more remote computing devices.

In at least one aspect, method 500 may include an operation by one or more processors to validate the one or more corresponding network drive mapping at the one or more remote computing devices.

In at least one aspect, method 500 may include an operation by one or more processors to communicate over the data network with a first unit.

In at least one aspect, method 500 may include an operation by one or more processors to maintain the dynamic mapping toolkit.

In at least one aspect, method 500 may include an operation by one or more processors to retrieve the set of user information from the file system database.

In at least one aspect, method 500 may include an operation by one or more processors to enable a user to generate mapping types.

In one aspect, method 500, or any aspect related to it, may be performed by a system, device, apparatus, or architecture, such as the enhanced mapping architecture of FIG. 4 or system 700 of FIG. 7, which includes various components operable, configured to, or adapted to perform the method 500. System 700 is described below in further detail.

FIG. 5 is just one example of a method, and other methods including fewer, additional, or alternative operations are contemplated consistent with the disclosure.

FIG. 6 is a schematic flowchart of an example method 600 for network drive mapping by one or more processors, such as processors of enhanced mapping architecture 400 of FIG. 4 and/or the processors of the system 800 of FIG. 8.

Method 600 begins at operation 602 one or more processors output a set of user information. In one example, the set of user information is generated based on at least one login event from one or more users at the device

Method 600 continues to operation 604 with one or more processors obtaining, from the first unit, one or more network drive mappings based on the set of user information. In one example, the one or more network drive mappings include at least one of personal drive mappings and business mappings. In one example, the one or more network drive mappings include group mappings.

Method 600 continues to operation 606 with one or more processors generating one or more corresponding network drive mappings.

Method 600 continues to operation 608 with one or more processors storing the one or more corresponding network drive mappings via one or more registration keys at the device.

In one aspect, method 600, or any aspect related to it, may be performed by a system, device, apparatus, or architecture, such as the enhanced mapping architecture of FIG. 4 or system 800 of FIG. 8, which includes various components operable, configured to, or adapted to perform the method 600. System 800 is described below in further detail.

FIG. 6 is just one example of a method, and other methods including fewer, additional, or alternative operations are contemplated consistent with the disclosure.

### Example Systems

FIG. 7 illustrates a schematic diagram of an example system 700, which includes a device 702. The system 700 may be implemented as part of the enhanced mapping procedures described with respect to FIGS. 1-6. The device 702 may be implemented at a single location or at multiple locations and may be a supervisory system component or may be in communication with a supervisory system component by way of a communication line and/or communication connection. In at least one aspect, the communication line and/or communication connection may be a wireless communication line, a wired communication line, or both, though other types of communication line or connection are contemplated.

The device 702 may include a CPU processing system, which may be configured to implement enhanced data processing, as performed by the system 700. The CPU processing system of the device 702 may include one or more processors 706 coupled to a computer readable medium/memory 704 (e.g., via a bus (not shown)). The one or more processors 706 and the computer readable medium/memory 704 may communicate via a message passing interface (MPI) 736 (or some other suitable communication interface). In certain aspects the computer readable medium/ memory 704 is configured to store instructions (e.g., computer executable code) that when executed by the one or more processors 706, cause the one or more processors to perform the method 500 described with respect to FIG. 5, or any aspect related to it. Reference to a processor performing a function of system 700 may include one or more processors performing that function of system 700.

In the depicted example, computer-readable medium/memory 704 stores code 708 (e.g., executable instructions) for obtaining, code 710 for outputting, and code 712 for outputting. Processing of code 708-712 may cause the system 700 to perform the method 500 described with respect to FIG. 5, or any aspect related to it.

The one or more processors 706 include circuitry configured to implement (e.g., execute) the code stored in the computer-readable medium / memory 704, including circuitry 722 for obtaining, circuitry 724 for constructing, and circuitry 726 for outputting. Processing with circuitry 722-726 may cause the system 700 to perform the method 500 described with respect to FIG. 5, or any aspect related to it.

Various components of the system 700 may provide means for performing the method 500 described with respect to FIG. 5, or any aspect related to it.

The system 700 may include or be substantially coupled to a communication component 738. In the depicted example, the communication component 738 is an antenna capable of communicating with systems or system components similar to system 700 to perform the method 500 described with respect to FIG. 5, or any aspect related to it. In additional examples, the communication component 738 may be a bus or a wired connection. In some embodiment, communication component 738 may facilitate interaction between system 700 and system 800 of FIG. 8.

FIG. 8 illustrates a schematic diagram of an example system 800, which includes a device 802. The system 800 may be implemented as part of the enhanced mapping procedures described with respect to FIGS. 1-6. The device 802 may be implemented at a single location or at multiple locations and may be a supervisory system component or may be in communication with a supervisory system component by way of a communication line and/or communication connection. In at least one aspect, the communication line and/or communication connection may be a wireless communication line, a wired communication line, or both, though other types of communication line or connection are contemplated.

The device 802 may include a CPU processing system, which may be configured to implement enhanced data processing, as performed by the system 800. The CPU processing system of the device 802 may include one or more processors 806 coupled to a computer readable medium/memory 804 (e.g., via a bus (not shown)). The one or more processors 806 and the computer readable medium/memory 804 may communicate via a message passing interface (MPI) 836 (or some other suitable communication interface). In certain aspects the computer readable medium/ memory 804 is configured to store instructions (e.g., computer executable code) that when executed by the one or more processors 806, cause the one or more processors to perform the method 500 described with respect to FIG. 5, or any aspect related to it. Reference to a processor performing a function of system 800 may include one or more processors performing that function of system 800.

In the depicted example, computer-readable medium/memory 804 stores code (e.g., executable instructions) 806 for outputting, code 808 for obtaining, code 810 for generating, and code 812 for storing. Processing of code 808-812 may cause the system 800 to perform the method 600 described with respect to FIG. 6, or any aspect related to it.

The one or more processors 806 include circuitry configured to implement (e.g., execute) the code stored in the computer-readable medium / memory 804, including circuitry 820 for outputting, circuitry 822 for obtaining, circuitry 824 for generating, and circuitry 826 for storing. Processing with circuitry 822-826 may cause the system 800 to perform the method 600 described with respect to FIG. 6, or any aspect related to it.

Various components of the system 800 may provide means for performing the method 600 described with respect to FIG. 6, or any aspect related to it.

The system 800 may include or be substantially coupled to a communication component 838. In the depicted example, the communication component 838 is an antenna capable of communicating with systems or system components similar to system 800 to perform the method 600 described with respect to FIG. 6, or any aspect related to it. In additional examples, the communication component 838 may be a bus or a wired connection. In some embodiment, communication component 838 may facilitate interaction between system 800 and system 700 of FIG. 7.

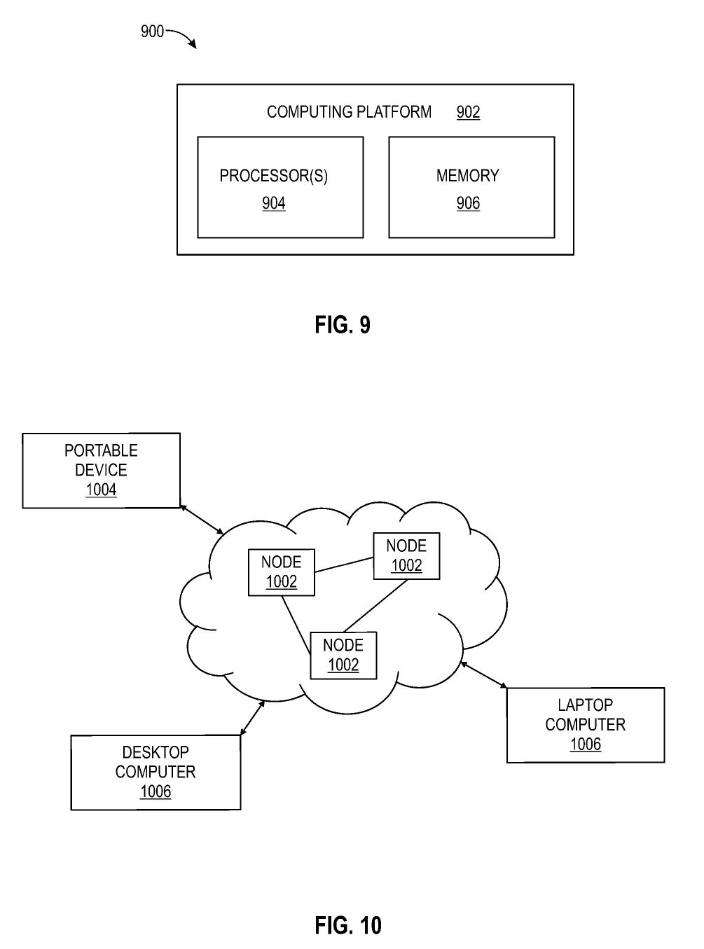

FIG. 9 is an example of a block diagram of a system 900. System 900 can be implemented using one or more modules, shown in block form in the drawings. The one or more modules can be in software or hardware form, or a combination thereof. In some examples, system 900 can be implemented as machine readable instructions for execution on one or more computing platforms 902 (referred to as a computing platform herein), as shown in FIG. 9. The computing platform 902 can include one or more computing devices selected from, for example, a desktop computer, a server, a controller, a blade, a mobile phone, a tablet, a laptop, a personal digital assistant (PDA), and the like.

The computing platform 904 can include a processor 904 and a memory 906. By way of example, the memory 906 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 904 can be implemented, for example, as one or more processor cores. The memory 906 can store machine-readable instructions that can be retrieved and executed by the processor 904 to implement the system 900 Each of the processor 904 and the memory 906 can be implemented on a similar or a different computing platform. The computing platform 902 can be implemented in a cloud computing environment (for example, as disclosed herein) and thus on a cloud infrastructure. In such a situation, features of the computing platform 902 can be representative of a single instance of hardware or multiple instances of hardware executing across the multiple of instances (e.g., distributed) of hardware (e.g., computers, routers, memory, processors, or a combination thereof). Alternatively, the computing platform 902 can be implemented on a single dedicated server or workstation.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (SaaS, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

FIG. 10 is an example of a cloud computing environment 1000 that can be used for implementing one or more modules and/or systems in accordance with one or more examples, as disclosed herein. Thus, reference can be made to one or more examples of FIGS. 1-11 in the example of FIG. 10. As shown, cloud computing environment 1000 can include one or more cloud computing nodes 1002 with which local computing devices used by cloud consumers (or users), such as, for example, personal digital assistant (PDA), cellular, or portable device 1004, a desktop computer 1006, and/or a laptop computer 1008, may communicate. The computing nodes 1002 can communicate with one another. In some examples, the computing nodes 1002 can be grouped (not shown) physically or virtually, in one or more networks, such as Private, Community, Public, or Hybrid clouds, or a combination thereof. This allows the cloud computing environment 1000 to offer infrastructure, platforms and/or software as services for which a cloud consumer does not need to maintain resources on a local computing device. The devices 1004-1008, as shown in FIG. 10, are intended to be illustrative and that computing nodes 1002 and cloud computing environment 1000 can communicate with any type of computerized device over any type of network and/or network addressable connection (e.g., using a web browser). In some examples, the one or more computing nodes 1002 are used for implementing one or more examples disclosed herein relating to root-source identification. Thus, in some examples, the one or more computing nodes can be used to implement modules, platforms, and/or systems, as disclosed herein.

In some examples, the cloud computing environment 1000 can provide one or more functional abstraction layers. It is to be understood that the cloud computing environment 1000 need not provide all of the one or more functional abstraction layers (and corresponding functions and/or components), as disclosed herein. For example, the cloud computing environment 1000 can provide a hardware and software layer that can include hardware and software components. Examples of hardware components include: mainframes; RISC (Reduced Instruction Set Computer) architecture based servers; servers; blade servers; storage devices; and networks and networking components. In some embodiments, software components include network application server software and database software.

In some examples, the cloud computing environment 1000 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 1000 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 1000, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 1000 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 1000 can provide a workloads layer that provides examples of functionality for which the cloud computing environment 1000 may be utilized. Examples of workloads and functions which may be provided from this layer include: mapping and navigation; software development and lifecycle management; virtual classroom education delivery; data analytics processing; and transaction processing. Various embodiments of the present disclosure can utilize the cloud computing environment 1000.

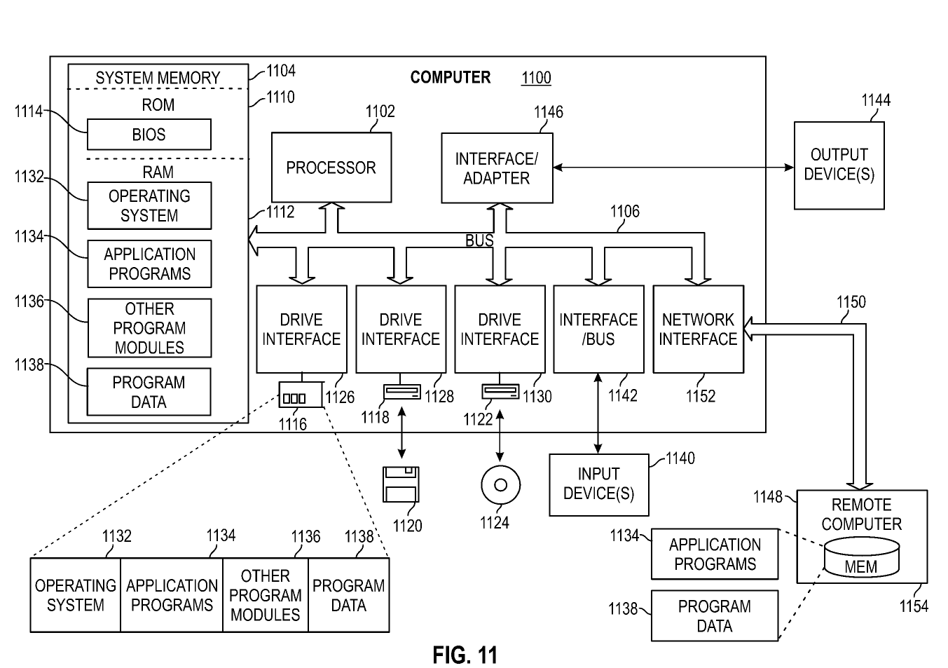

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 11. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 11 illustrates one example of a computer system 1100 that can be employed to execute one or more embodiments of the present disclosure. Computer system 1100 can be implemented on one or more general purpose networked computer systems, embedded computer systems, routers, switches, server devices, client devices, various intermediate devices/nodes or standalone computer systems. Additionally, computer system 1100 can be implemented on various mobile clients such as, for example, a personal digital assistant (PDA), laptop computer, pager, and the like, provided it includes sufficient processing capabilities.

Computer system 1100 includes processing unit 1102, system memory 1104, and system bus 1106 that couples various system components, including the system memory 1104, to processing unit 1102. System memory 1104 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 1102. System bus 1106 may be any of several types of bus structure including a memory bus or memory controller, a peripheral bus, and a local bus using any of a variety of bus architectures. System memory 1104 includes read only memory (ROM) 1110 and random access memory (RAM) 1112. A basic input/output system (BIOS) 1114 can reside in ROM 1110 containing the basic routines that help to transfer information among elements within computer system 1100.

Computer system 1100 can include a hard disk drive 1116, magnetic disk drive 1118, e.g., to read from or write to removable disk 1120, and an optical disk drive 1122, e.g., for reading CD-ROM disk 1124 or to read from or write to other optical media. Hard disk drive 1116, magnetic disk drive 1118, and optical disk drive 1122 are connected to system bus 1106 by a hard disk drive interface 1126, a magnetic disk drive interface 1128, and an optical drive interface 1130, respectively. The drives and associated computer-readable media provide nonvolatile storage of data, data structures, and computer-executable instructions for computer system 1100. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

Computer system 1100 may operate in a networked environment using logical connections to one or more remote computers, such as remote computer 1148. Remote computer 1148 may be a workstation, computer system, router, peer device, or other common network node, and typically includes many or all the elements described relative to computer system 1100. The logical connections, schematically indicated at 1150, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 1100 can be connected to the local network through a network interface or adapter 1152. When used in a WAN networking environment, computer system 1100 can include a modem, or can be connected to a communications server on the LAN. The modem, which may be internal or external, can be connected to system bus 1106 via an appropriate port interface. In a networked environment, application programs 1134 or program data 1138 depicted relative to computer system 1100, or portions thereof, may be stored in a remote memory storage device 1154.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

### Example Clauses

Implementation examples are described in the following numbered clauses:

Clause 1: A system, including a drive mapping service implemented on a first unit and configured to communicate over a data network with one or more remote computing devices, the first unit having a memory and one or more processors coupled to the memory; a dynamic mapping toolkit implemented on the drive mapping service, the dynamic mapping toolkit configured to cause the one or more processors to: obtain a set of user information; in response to the set of user information, construct one or more network drive mappings; and output the one or more network drive mappings to the one or more remote computing devices, the one or more network drive mappings configured to generate one or more corresponding network drive mappings at the one or more remote computing devices.

Clause 2: The system of clause 1, wherein the dynamic mapping toolkit is further configured to cause the one or more processors to, after outputting the one or more drive mappings, detect receipt of the one or more network drive mappings at the one or more remote computing devices.

Clause 3: The system of clause 2, wherein the dynamic mapping toolkit is further configured to cause the one or more processors to validate the one or more corresponding network drive mapping at the one or more remote computing devices.

Clause 4: The system of any one of clauses 1 through 3, wherein the one or more network drive mappings include at least one of personal drive mappings and business mappings.

Clause 5: The system of any one of clauses 1 through 4, wherein the one or more network drive mappings include group mappings.

Clause 6: The system of any one of clauses 1 through 6, wherein the system further includes a file system database implemented on a second unit, the second unit configured to communicate over the data network with the first unit.

Clause 7: The system of clause 6, wherein the file system database is configured to maintain the dynamic mapping toolkit.

Clause 8: The system of any one of clauses 7 through 8, wherein the first unit is configured to retrieve the set of user information from the file system database.

Clause 9: The system of any one of clauses 1 through 8, wherein the set of user information is generated based on at least one login event from one or more users at the one or more computing devices.

Clause 10: The system of any one of clauses 1 through 9, wherein the system further includes a system administrator device having a drive mapping interface.

Clause 11: The system of any one of clauses 1 through 10, wherein the drive mapping interface is configured to enable a user to generate mapping types.

Clause 12: A device, including a drive mapping client implemented on the device and configured to communicate over a data network with a first unit; a dynamic mapping tool implemented on the drive mapping client, the dynamic mapping tool configured to cause the one or more processors to: output a set of user information; obtain, from the first unit, one or more network drive mappings based on the set of user information; generate one or more corresponding network drive mappings; store the one or more corresponding network drive mappings via one or more registration keys at the device.

Clause 13: The device of clause 11, wherein the one or more network drive mappings include at least one of personal drive mappings and business mappings.

Clause 14: The device of any one of clauses 12 through 13, wherein the one or more network drive mappings include group mappings.

Clause 15: The device of any one of clauses 12 through 14, wherein the set of user information is generated based on at least one login event from one or more users at the device.

Clause 16: The device of any one of clauses 12 through 15, wherein the dynamic mapping tool further includes a user-facing interface configured to enable a user to perform login events.

Aspect 17: An apparatus or device including a memory comprising executable instructions, and a processor configured to execute the executable instructions and cause the apparatus to perform a method in accordance with any one of clauses 1-16.

Aspect 18: An apparatus or device, including means for performing a method in accordance with any one of clauses 1-16.

Aspect 19: A non-transitory computer-readable medium including executable instructions that, when executed by a processor of an apparatus, cause the apparatus to perform a method in accordance with any one of clauses 1-16.

Aspect 20: A computer program product embodied on a computer-readable storage medium comprising code for performing a method in accordance with any one of clauses 1-16.

The present disclosure may be a system, a method, and/or a computer program product at any possible technical detail level of integration. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to aspects of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular aspects only and is not intended to be limiting of the disclosure. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 5-10% of the indicated number.

While the disclosure has described several exemplary aspects, it will be understood by those skilled in the art that various changes can be made, and equivalents can be substituted for elements thereof, without departing from the spirit and scope of the disclosure. In addition, many modifications will be appreciated by those skilled in the art to adapt a particular instrument, situation, or material to aspects of the disclosure without departing from the essential scope thereof. Therefore, it is intended that the disclosure not be limited to the particular aspects disclosed, or to the best mode contemplated for carrying out this disclosure, but that the disclosure will include all aspects falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A system, comprising:
a drive mapping service implemented on a first unit and configured to communicate over a data network with one or more remote computing devices, the first unit having a memory and one or more processors coupled to the memory;
a dynamic mapping toolkit implemented on the drive mapping service, the dynamic mapping toolkit configured to cause the one or more processors to:
obtain a set of user information;
in response to the set of user information, construct one or more network drive mappings; and
output the one or more network drive mappings to the one or more remote computing devices, the one or more network drive mappings configured to generate one or more corresponding network drive mappings at the one or more remote computing devices.

2. The system of claim 1, wherein the dynamic mapping toolkit is further configured to cause the one or more processors to, after outputting the one or more drive mappings, detect receipt of the one or more network drive mappings at the one or more remote computing devices.

3. The system of claim 2, wherein the dynamic mapping toolkit is further configured to cause the one or more processors to validate the one or more corresponding network drive mapping at the one or more remote computing devices.

4. The system of claim 1, wherein the one or more network drive mappings comprise at least one of personal drive mappings and business mappings.

5. The system of claim 1, wherein the one or more network drive mappings comprise group mappings.

6. The system of claim 1, wherein the system further includes a file system database implemented on a second unit, the second unit configured to communicate over the data network with the first unit.

7. The system of claim 6, wherein the file system database is configured to maintain the dynamic mapping toolkit.

8. The system of claim 6, wherein the first unit is configured to retrieve the set of user information from the file system database.

9. The system of claim 1, wherein the set of user information is generated based on at least one login event from one or more users at the one or more computing devices.

10. The system of claim 1, wherein the system further includes a system administrator device having a drive mapping interface.

11. The system of claim 10, wherein the drive mapping interface is configured to enable a user to generate mapping types.

12. A device, comprising:
a drive mapping client implemented on the device and configured to communicate over a data network with a first unit;
a dynamic mapping tool implemented on the drive mapping client, the dynamic mapping tool configured to cause the one or more processors to:
output a set of user information;
obtain, from the first unit, one or more network drive mappings based on the set of user information;
generate one or more corresponding network drive mappings; and
store the one or more corresponding network drive mappings via one or more registration keys at the device.

13. The device of claim 12, wherein the one or more network drive mappings comprise at least one of personal drive mappings and business mappings.

14. The device of claim 12, wherein the one or more network drive mappings comprise group mappings.

15. The device of claim 12, wherein the set of user information is generated based on at least one login event from one or more users at the device.

16. The device of claim 12, wherein the dynamic mapping tool further includes a user-facing interface configured to enable a user to perform login events.
